(19) United States
(12) Patent Application Publication
(10) Pub. No.: US 2007/0245002 A1
(43) Pub. Date: Oct. 18, 2007

(54) Community-based information view, management and delivery system with micro-access control for data view and data scope

(76) Inventors: Huy Nguyen, Cupertino, CA (US); Perpetua Tranlong, Cupertino, CA (US)

Correspondence Address: OFFICE OF DONALD GRANT KELLY;INTELLECTUAL ASSET MANAGEMENT ASSOCIATES, LLC, 515 KING STREET, SUITE 420, ALEXANDRIA, VA, 22314, US

(21) Appl. No.: 11/404,238

(22) Filed: Apr. 15, 2006

(51) Int. Cl. G06F 15/173

(52) U.S. Cl. 709/223

(57) ABSTRACT

A computer-implemented data view management system is provided in which data search, view, presentation, and management are conducted in a community-based concept that allows for managers of a community to control users' access to data views data scopes, attributes, data, and action items at a community-wide level, a subcommunity level and individual-user level to allow the most flexibility in control of users, data and information across a plurality of databases and users. More particularly, the invention relates to a community-based system for data view, management, search and tracking system which can be operated in conjunction with and parallel to existing enterprise resource planning software, and within which managers and users exercise maximum flexibility in setting their data views and data scopes within the limits set by their assigned community or subcommunity, and within which data, transaction, communication and information can be updated dynamically and interactively in response to changes or as a result of prior user-initiated transactions, and within which data views, data scopes and executable functions are presented to each user and manager uniquely based on the user's uniquely-identified criteria and his assignment to a particular community, and within which transaction data and usage are tracked, stored and maintained dynamically and iteratively for future access, organization and archival.

### STATEMENT REGARDING FEDERALLY SPONSORED RESEARCH OR DEVELOPMENT

Not applicable.

### INVENTORS' NAMES

Huy Nguyen and Perpetua Tranlong

### FIELD OF THE INVENTION

The present invention relates generally to a community-based dynamic and iterative system to control how a large set of diverse business managers and users can access data views and data scopes of a universe of data, data objects and actions from one or more databases, with access control set in multi-levels such that a manager of a virtual community can dynamically control how his virtual community, subcommunities, submanagers and users see, access and act on specific data views and data scopes. More particularly, it pertains to an Internet browser-based portal-style method and system to allow an individual manager without database background and knowledge (e.g., business managers) to create virtual web communities and subcommunities of other users to access, manage, control, view and act on an information depository with logic filters to regulate access to data and information of the users through the control of data view and data scope.

### BACKGROUND ART

Organizations and business enterprises today are dealing with problem of delivering data across the enterprise at a time when the volume and types of data are increasing exponentially, the sources from which data arrive are also increasing exponentially, and the number of types of users desiring viewing access are also increasing exponentially. Much data is created, but problems persist in creating a comprehensive single view system across the enterprise to collect, filter, access, display and record the use of this exploding universe of data describing customers, location, business partners, outsourcers, products, and the complex interaction among these data. Putting control of data into the hands of individual users and business managers (instead of technical staff) while maintaining a centralized systems of records and data is a daunting challenge, but it is a critical problem that needs to be solved so that enterprises and their business managers can properly control access to sensitive business data, track access, usage and impact of the data, and better comply with increasing governmental regulations such as the new HIPPAA law, Sarbannes-Oxley law and new governmental anti-terrorism initiatives.

In addition, organizations and business enterprises must adapt to the evolving browser-based business applications driven by the development of the Internet and the World Wide Web. The Internet and the World Wide Web became a social infrastructure for data sharing and information management because the Internet can efficiently process and classify a large amount of diverse information resources within an enterprise and among disparate enterprises and make such data and information available to a large set of users around the globe with different demands and pricing sensitivity for such information and data. However, the explosion of data and information available through the Internet highlights the need for new solutions for key problems in managing such information and data and the users and managers who need access to such data, such as access control, data retrieval, audit trails, resource management, scalability and cost-effectiveness. Current methods of managing information and data rely principally on complex Enterprise Resource and Planning system (ERP), which is principally designed to be managed and controlled by dedicated technical staff, rather than by the business managers or end users. However, a great need exists for a new method and system to allow the business and end users of the data to dynamically control sensitive and strategic data and information and to properly track access and view of business data. This problem is even more complex in the Internet age because of the diffuse nature of the Internet and the time-sensitive and cost-sensitive nature of the Internet-based enterprise. Furthermore, when users should no longer be able to access and view the data (because they were removed from payroll, or transferred out of department, or for other reasons), there is no easy method for the business managers to easily remove these viewers from access to this wide spread of data of the enterprise in the evolving data universe.

Consider the business problems in a situation where an enterprise outsources their manufacturing to other companies which are simultaneously business partners and business competitors. This is a very common scenario in the current world market. For various efficiency and cost reasons, a lot of their competing products will share common commodity parts. These partners/competitors need common access to certain product data and information in order to collaborate. However, just as important, each partner/competitor has very strong needs to safeguard and shield other key critical data frits partners/competitors. Which data needs to be shared and which data needs to be shielded is a business decision being made and updated constantly by the business manager, not the technical staff of the enterprise. Decisions are made real-time and need to be updated dynamically in real time and iteratively across the supply chain and the data chain. The prior art ERP and planning system has no effective methods to address these problems because existing systems are designed to exist within an enterprise (not across enterprise) and because existing systems are not designed to be dynamically controlled by the business managers in real time.

A simplified way to understand the prior art ERP and planning system as compared to the method disclosed in this patent application is as follows. Imagine data and information as food items on a restaurant menu (only in much greater quantity and types than any single restaurant can offer). Each customer walking in currently has to depend on the wait staff and the chef to deliver the menu, makes his menu choice the menu and then wait for delivery. Customers are typically limited to on-menu items. If the customer wants to customize his choice (i.e., order off-menu selection), the chef has to be consulted, and an individual selection has to be created and prepared, often at much greater costs than standard menu item. If the customer is still unhappy with his choice, the entire process has to be repeated, or the customer has to go without his preferred food. A set up of this type works fairly well in a smaller restaurant operation, or where the restaurant has severely limited the choices of the customers to a defined set of pre-selected items. However, if the goal is to create a super-restaurant offering thousands and thousands of choices and serving hundred of thousands of customers, the system and the restaurant management will quickly overload.

Instead, imagine that each food item is now an item or an attribute in a super buffet, where every customer can self-service and customize his or her own entree. However, access to the buffet is not granted until the customer has been assigned to a community, each with its own manager who acts as a gatekeeper. Each community has a manager (who does not have to be a chef or a trained wait staff), and each group is assigned only the specific food items that have been pre-ordered by the manager. For example, a manager can pre-order enough food for 25 people limited to 50 pre-selected food items. When a diner comes in, the wait staff confirms the identity of the diner and his assignment to a particular group. A diner can belong to more than one communities, but at any time that he desires access to the buffet, he had to choose a particular group assignment for the wait staff to serve him. Then the diner can select only from the pre-selected food items. When all 25 members of the group has been served or when the pre-assigned dining time has expired, the buffet is cleared away. The wait staff and the chef has no independent need to confirm or serve the individual meals of the diner, nor do diners need to access the restaurant staff for any customization of the food choices they make. In this way, demands on direct restaurant staff are minimal, while the diners' choices and customization are optimized through the use of the community concept.

Furthermore, the group leader, i.e., the manager in this scenario can be empowered with micro-control over his group without any need to involvement from the restaurant staff. Consider, for example, the scenario where some individual members of the group are diet-restricted. The manager can pre-order vegetarian items in his buffet menu, then restrict the choices of certain individual members to only vegetarian items, without the need to involve any restaurant staff, and certainly would not need to customize the menu or order off-menu items. A manager can also create new subcommunities, for examples, a group dining at 12:30 p.m. and a group dining at 1:30 p.m.; the manager can pick different food items for each group, sets different limitations, even prearrange the seating arrangement separate for each group, with each user then free to make the choices within the limits set by the manager for the community and further within the limits set by the manger for such individual user or group of users, if any (e.g., only vegetarian items available to be served to vegetarians).

Optionally, the manager can record the choices and actions of his group members and pass on the results to the restaurant wait staff and the chef so that buffet menu can be changed or optimized for the next dining event. Information flows back to the group manager which can then influence the next set of delivery.

The Internet offers the enterprise the opportunity and the challenge for an entity to become this super-restaurant serving up an unlimited choice of information to millions of users-diners. The challenge is to optimize the delivery of information while imposing control on access to the information, and the most effective person to impose control is the business manager, i.e., the group leader who sets control over the buffet items that his group can access.

The Internet is a complex environment where information is distributed across the Internet's infrastructure among many disparate databases and enterprises. Each underlying database has its own rules, method and system to control access, display and deliver information and data, and safeguard sensitive information such as technology secrets, business data and personal records. However, the needs of enterprises and users on the Internet also often require that data and information from many disparate databases be collected, shared, displayed and delivered to a multitude of users in real time and iteratively. This sharing of information requires its own method and system to control access, display, management and delivery of information and data, which needs are not addressable at the level of the individual databases.

Today, numerous information management systems, tools and products exist to manage and control access with respect to each “group” of users. However, in the existing information management system, access control is integral to database management and is a feature of the database management system. Changes to access control are made at the technical level by technical staff and necessitates regrouping, reconfiguration of reports, rerun of reports and reordering of access by the technical staff (in our example above, the technical staff is similar to the overworked wait staff and restaurant managers). Oftentimes, business managers (i.e., the group leaders or managers in our example above who have no experience in running a restaurant or a kitchen but just need to feed his group of 25 people within his budget and according to their choices) have very little inputs into the technical changes, little transparency into the timing and scope of the changes, and have to wait until the reports have been rerun to determine whether the changes are acceptable from a business standpoint. By that time, business opportunities may have gone away, key information may already have been leaked, and inefficiencies and waste have already occurred. To increase efficiency, optimize business opportunities and decrease costs, changes must be made optimally dynamically and in real-time to accommodate the business needs.

Furthermore, where data is collected from a plurality of databases or a plurality of ERP systems and must then be shared, displayed and delivered to a multitude of users in real time and iteratively, such as on an Internet-based application, access control which is part of any one database management system cannot be used to manage data across the plurality of databases or a plurality of ERP systems. A new method is required to aggregate data and control data display and delivery across the plurality of databases, applications, data views and data sources. This method should be capable of handling large numbers of data and users, provide a new method of controlling the display, management and delivery of information and data, put access and control into the hands of the business managers (and away from technical staff) and provide real-time and iterative responses to information requests. Just as important, this method should be capable of being managed and updated by the business managers in real time without the direct input and supervision of the technical staff. Finally, this new method needs to operate independently of the underlying data in the plurality of databases to eliminate any possibility of data corruption, losses and disturbances of other enterprise needs.

The advantages of the new method and system includes at least the following:
1. Permit the business managers to create, delete, control and modify a virtual community, with subcommunities embedded within such virtual community, and in turn control access of the data by the users within the community or subcommunities through the control of data views and data scopes across disparate databases and disparate software applications from multiple enterprises without compromising any underlying database;
2. Permit the business managers to exercise maximum flexibility and individual control at all levels of community, subcommunities, submanagers and users within the community;
3. Simplify the transfer and access to data through the creation of virtual community and subcommunities and permitting the managers to assign data, attributes, data view, data sources to an entire community or subcommunity, such that if a new attribute is added, it is by default added to the entire community, and if one is deleted, it is deleted from an entire community;
4. Implement a “single view” system of accessing and viewing information across the enterprise and across multiple platforms and viewing points to improve synchronization, transparency and efficiency;
5. Automatically generate audit trails and records of all viewing activities by users, locations, times and other criteria to significantly improve data access security, compliance issues, reduce inappropriate and unauthorized access to sensitive business data;
6. Put control and management of data views and data access in the hands of the business managers across disparate databases in realtime to allow for accurate and efficient business decisions. Through the creation, deletion and management of the communities and subcommunities, the users and the attributes for each community, the business managers can grant access, limit access, change access, control access or even revoke access dynamically and iteratively to a user or group of users;
7. Improve transparency and reports to the business managers, in that the business managers for a community can view and control access to the data at the micro-level for each user by location, time of access, view groups and other criteria which can be determined and dynamically changed by the business managers.

### SUMMARY AND DETAILED DESCRIPTION OF THE INVENTION:

The present invention in its several disclosed embodiments combine best of breed in information access control, management and display systems with a new community-based concept that allows for managers of a virtual community to control access by users to data views, data scopes, attributes, data, and action items at a community-wide level, a subcommunity level and individual-user level to allow the most flexibility in controlling access to of data and information across a plurality of databases, software applications, managers and users.

An object of the present invention is to provide a method and system that allows for the most flexible and controlled access to data views, data scopes, data, software and information in multi-levels of virtual community, subcommunities and users across disparate databases, user group, software applications and enterprises without compromising any underlying database.

A further object of the present invention is to provide a method and system that allows for the implementation of a “single view” system of accessing and viewing information across the enterprise and across multiple platforms and viewing points to improve synchronization, transparency and efficiency.

Still another object of the present invention is to provide a method and system that allows the business managers to view and control access to the data views, data scopes, data, software and information in multi-levels of community, subcommunities and users data by one or many criteria such as location, time of access, data sources and other criteria which can be chosen or deleted dynamically on the fly and changed on the fly by the business managers.

Still another object of the present invention is to provide a method and system which can dynamically and iterative update and populate throughout the system newly arrived transaction information, and other data and business solutions within the system.

Still other objects, features and advantages of the present invention will be readily apparent in one skilled in the art from the following description. The drawings and descriptions are to be regarded as illustrative in natures, and are not to be restrictive. What is intended to be protected by Letters Patent is as set forth in the appended claims. The present invention will become apparent when taken in conjunction with the following description and attached drawings, wherein like characters indicate like parts, and which drawings form a part of this application.

### BRIEF DESCRIPTION OF THE DRAWINGS

FIG. 1 is an overview of the community concept underlying the present invention as disclosed in this application.

FIG. 2 and attached Glossary of Terms together form a block diagram of the preferred embodiment Information View, Management and Delivery System (IVMDS) in accordance with the present invention as disclosed in this application.

FIG. 3 is an example workflow which could be implemented in the IVMDS shown in FIG. 2 for the operational activities of Managers using the software routine supported by the IVMDS shown in FIG. 2 to control access by Users to the IVMDS and the communities and subcommunities within the IVMDS.

FIG. 4 is an example workflow and example software screenshot which could be implemented in the IVMDS shown in FIG. 2 for the operational activities of Managers using the software routine supported by the IVMDS shown in FIG. 1 to register new virtual communities and subcommunities, assign view groups and process groups to the newly-created communities.

FIG. 5 is an example workflow with example software screenshots (FIG. 5a and FIG. 5b), which could be implemented in the IVMDS shown in FIG. 2 for the operational activities of Managers using the software routines supported by the IVMDS shown in FIG. 2 to register, add, delete and manage new Users and Managers.

FIG. 6 is an example workflow with an example software screenshot (FIG. 6a) which could be implemented in the IVMDS shown in FIG. 1 for the operational activities of Managers using the software routine supported by the IVMDS shown in FIG. 2 to register new attributes.

### DETAILED DESCRIPTION OF THE INVENTION

In the following description of the invention, further reference is made to the accompanying drawings which form a part hereof, and in which is shown by way of illustration the specific embodiment in which the invention may be practiced. It is to be understood that other embodiments may be utilized as structural changes may be made without departing from the scope of the present invention.

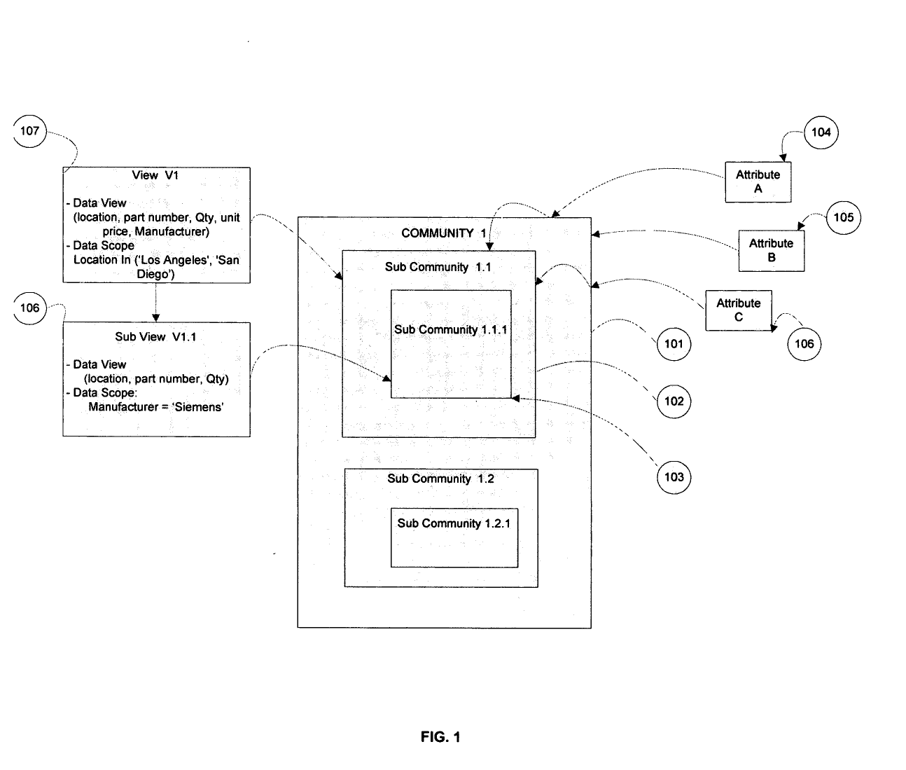

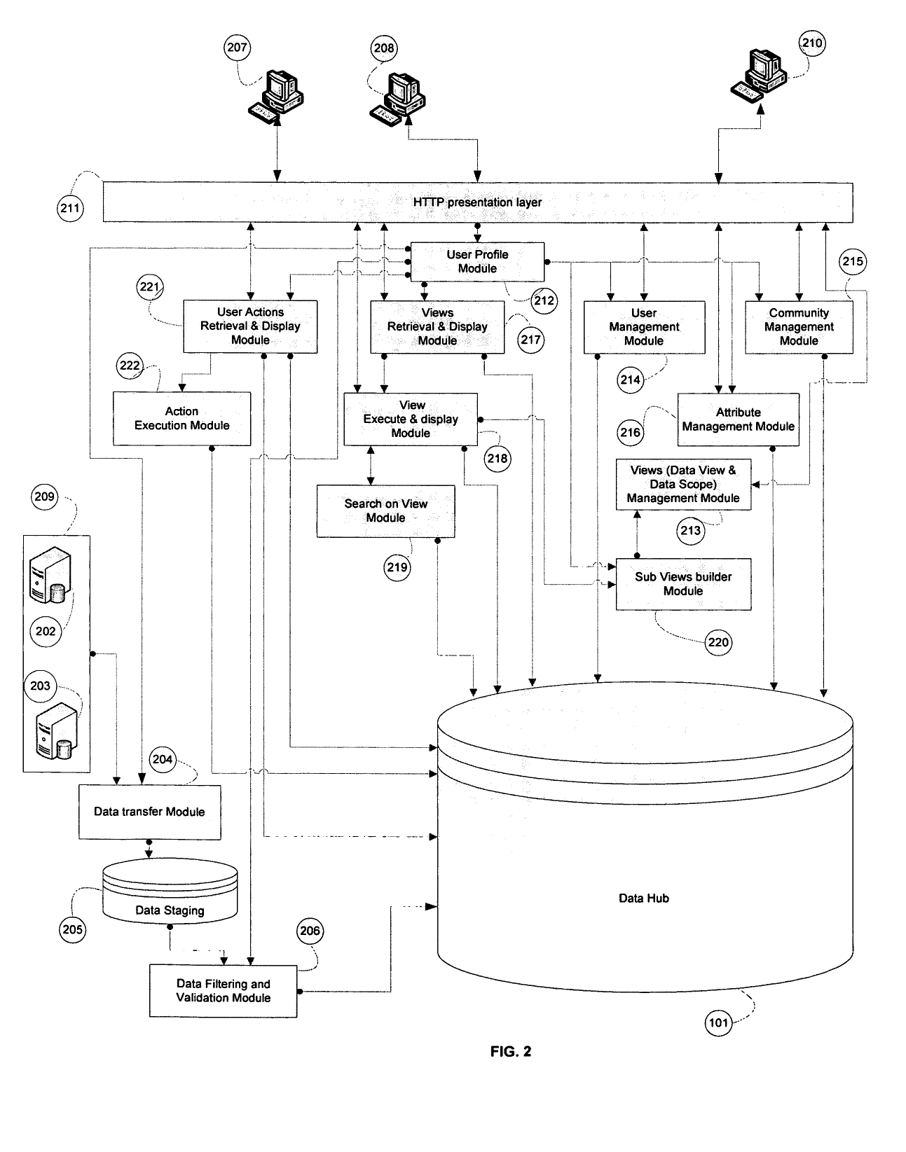

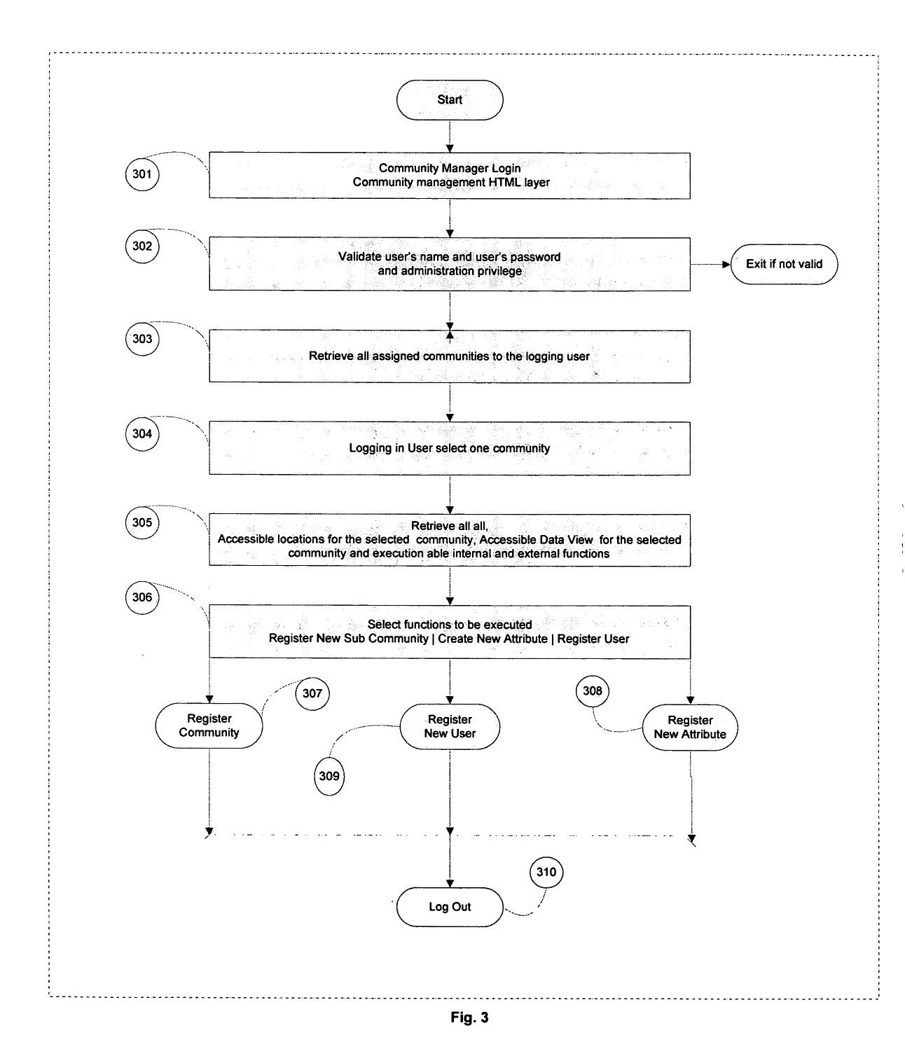

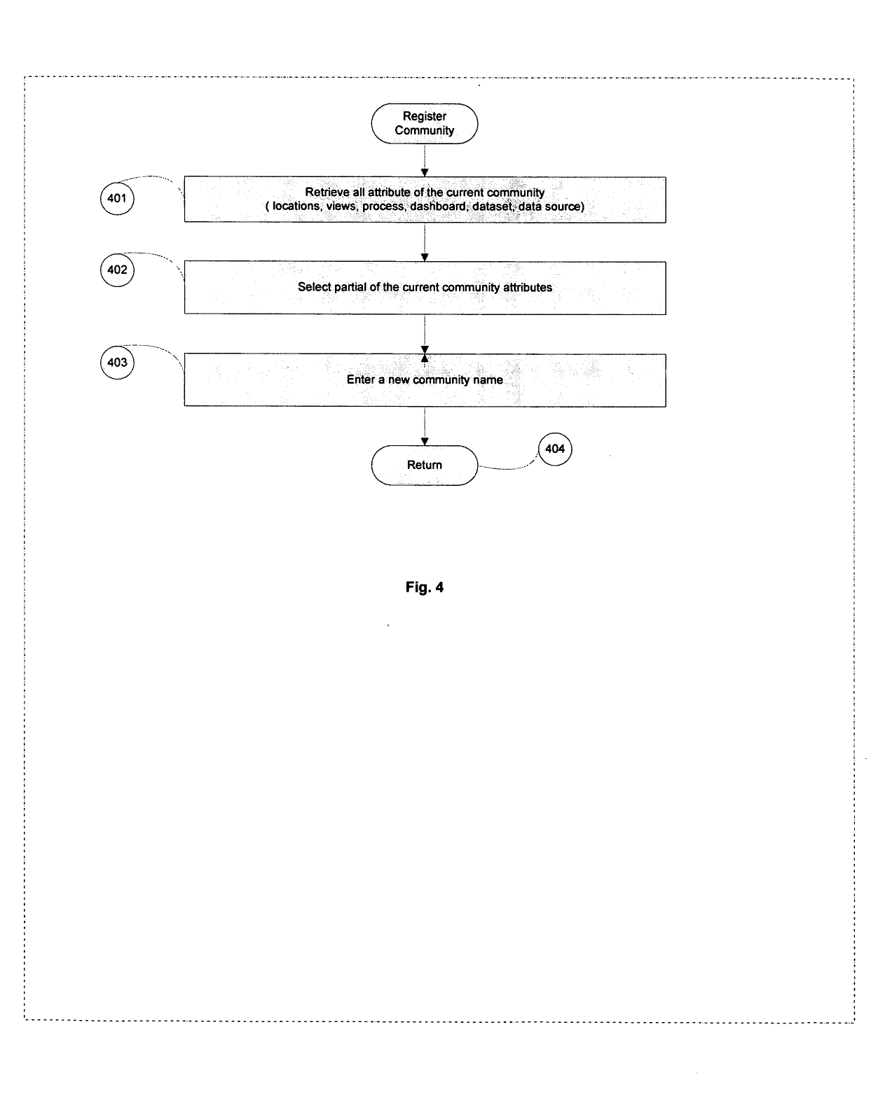

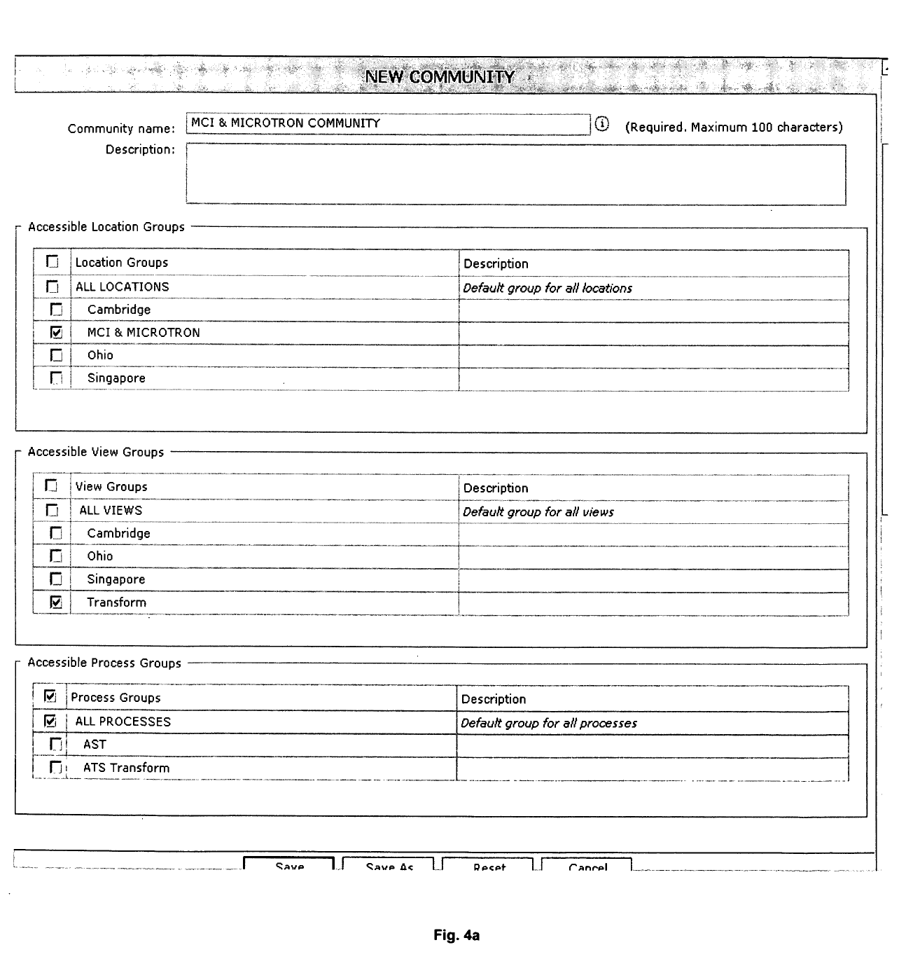

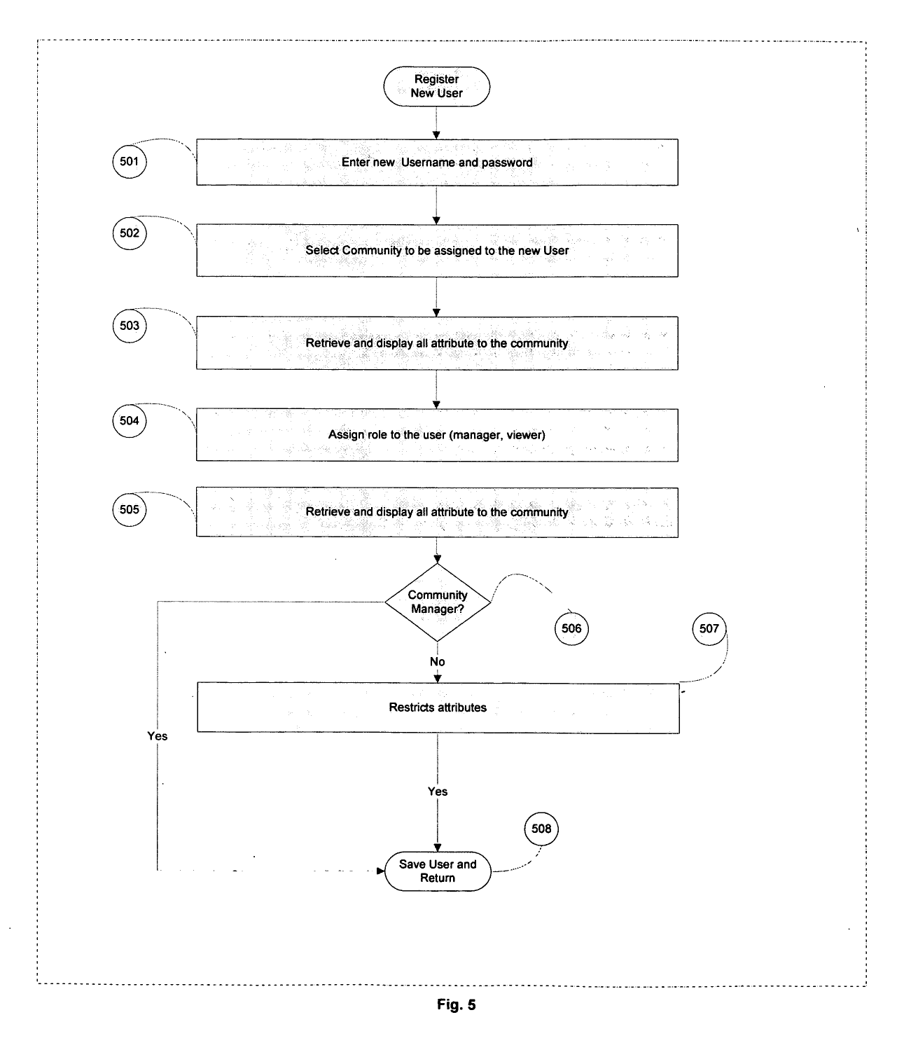

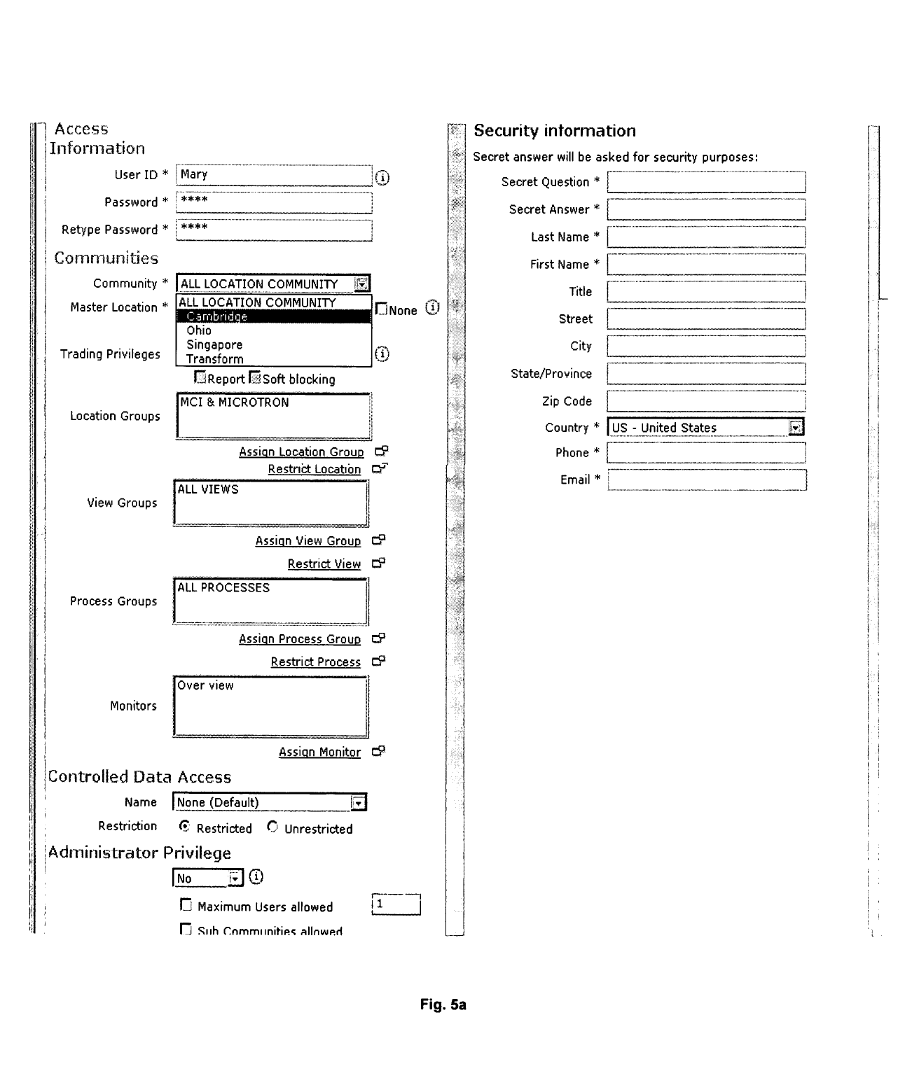

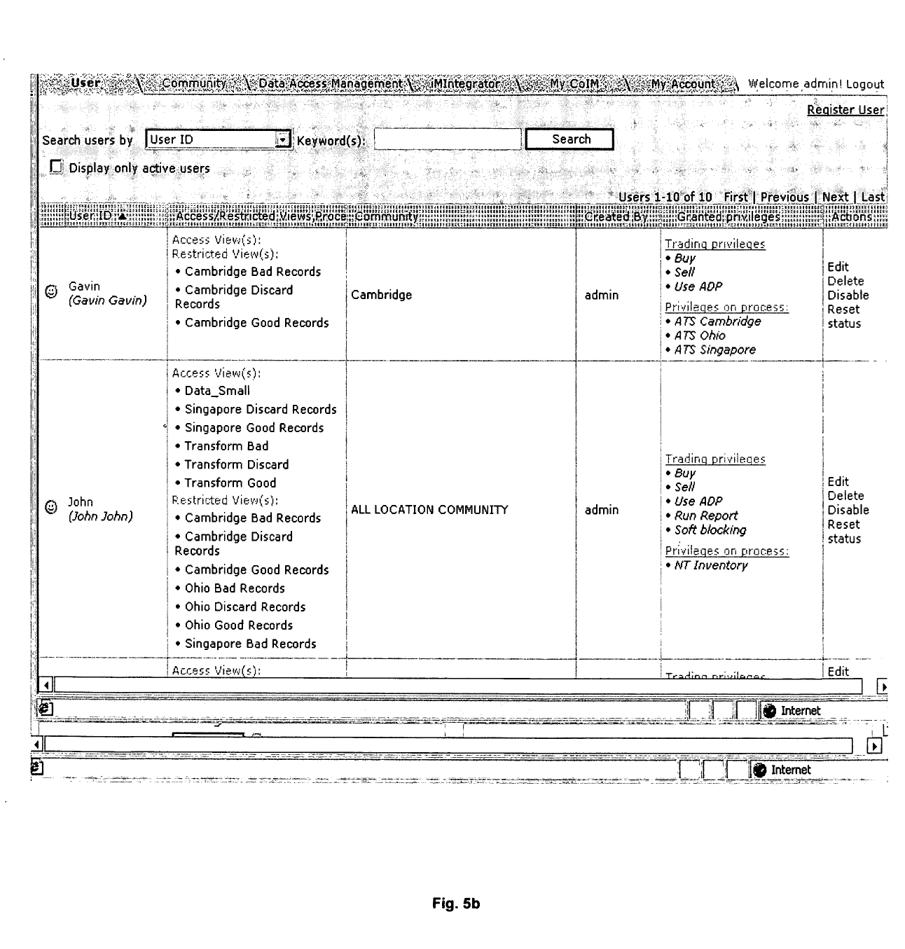

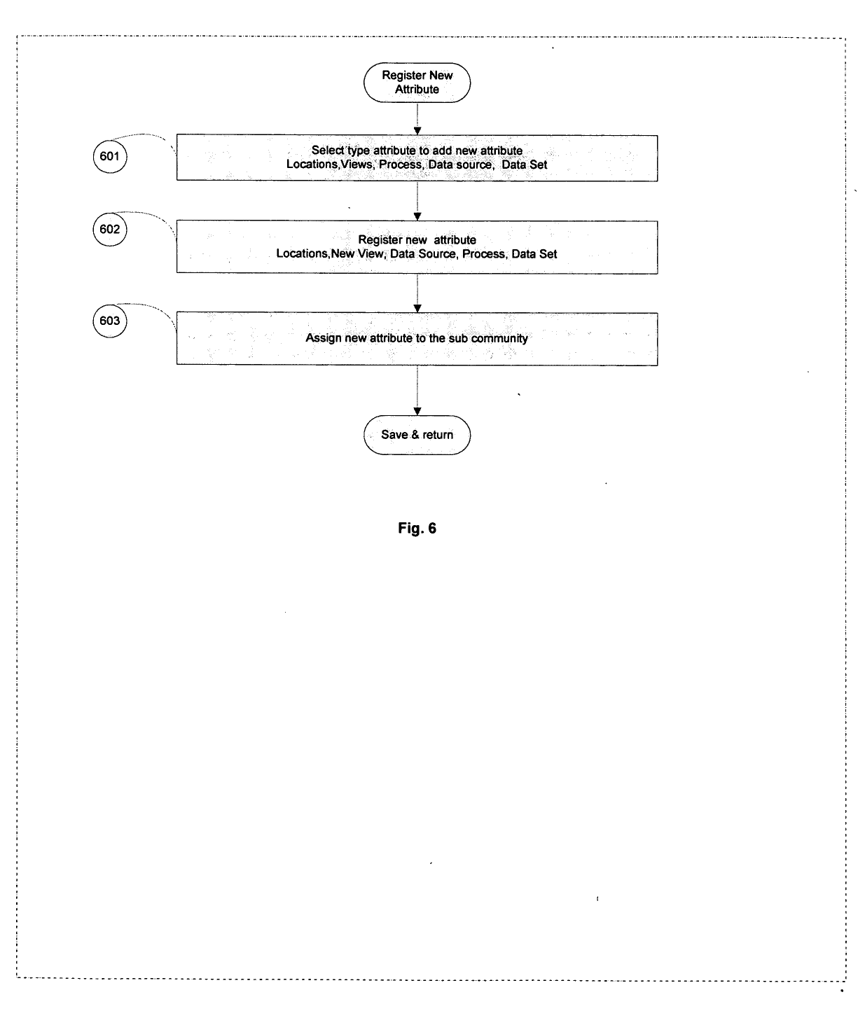

Referring now to FIG. 1 and the Glossary of Terms attached to FIG.2, an overview of the community concept underlying the present invention as disclosed in this application is shown. A Community 101 refers to the IVMDS-defined virtual community consisting of Users and Managers working collaboratively through the IVMDS and its graphical user interface called the HTTP Presentation Layer to access Data Source, Data Views, Data Scopes, and to carry out the actionable transactions supported by the IVMDS. By default, each IVMDS system has at least one community and multiple levels of subcommunties each nested within the higher-level community 102 103. At any time, anywhere through Internet access, the manager of the higher level community can create a subcommunity and sub-sub-communities (See FIG. 4), assign a manager for the new subcommunity (See FIG. 5) and all lower-level communities created by the managers of the lower-level communities (hence the nested characteristics of subcommunities), add, remove and manage Users and Users' ability to access Data Views and Data Scopes (See FIG. 3), and in turn, managers of the lower-level community can do all management activities for his assigned Community and lower-level community.

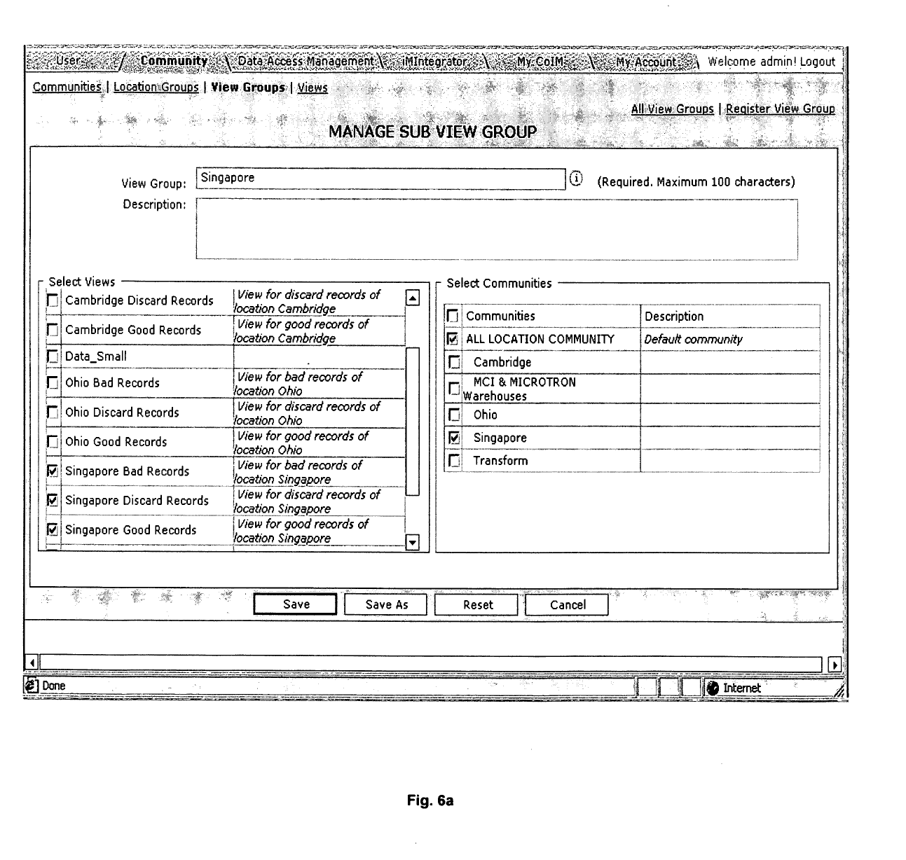

Any User assigned to a Community has full access to all the types of data, types of views, actionable items, executable reports, privileges and features of the Community unless otherwise restricted by the Manager of the Community. In FIG. 1, the Attributes 104 105 106 refers to the different types of data, views, actionable items, executable reports, privileges and features of a Community. Managers assign Attributes to the Subcommunity (see FIG. 6) and also restrict their uses, which restrict all subcommunities and users within the subcommunities. In FIG. 1, for example, Attribute A 104, Attribute B 105 and Attribute C 106 are all assigned to Community 1 101. The Manager of Community 1 elects to assign only Attribute A 104 and Attribute C 106 to Subcommunity 1.1, which means that all Users of Subcommunity 1.1 only have access to see Attribute A and Attribute C, whereas Users of Community 1 can view Attributes A, B or C, unless they are otherwise restricted by the Manager of Community 1. Users can be assigned to multiple Communities and Subcommunities, but each User can choose to access only one such Community and Subcommunity at any log-in session.

Because a Manager can control access to Data Views and Data Scopes for the entire virtual Community, for a single Subcommunity or selection of Subcommunities, for a single User or selection of Users, the Manager has macro- and micro-access control for the use and view of data within the IVMDS. Similarly, a User has full control as to how his individual Data View and Data Scopes can be presented, to the extent that the User has been granted access by the Manager of the Community.

A Community Manager can “close” any subcommunity nested within his Community, and this will close access to all Users within the Subcommunity. A Community Manager can reopen a deactivated Subcommunity and this will restore access to all Users within the Community.

A Manager can also restrict the Views 107 for all or any or a selection of Users and Subcommunities within his Community. A View 107 consists of a Data View, which refers to the types of data presented to the Users, e.g., location, part number, quantity, unit price, manufacturer, etc. and Data Scope, which refers to the sources from which data is pulled to be presented to the Users, e.g., the warehouses in Los Angeles, the store inventory in Dallas, etc. A Manager or User can also set a Subview 108 by restricting the Data Views and Data Scopes to less than the entire Data View and Data Scope to which such Users can access. Views, Data Views and Data Scopes are all Attributes which can be managed just as other Attributes within the IVMDS.

Referring now to FIG. 2 and its accompanying Glossary of Terms, a block diagram of the preferred embodiment IVMDS system 100 in accordance with the present invention is shown.

The present invention of a system to display, manage and deliver information and data with micro access control for data view and data scope includes the following steps:
1. The Information System (IS) department of the business enterprise establishes a host-operated inventory hub (herein called Hub), consisting of an information management system hosted on a computer server (or a plurality of computer servers) having information processing capabilities, storage capabilities and data display capabilities, and electronic communication connection into the Internet or Intranet such as T-1 or T-3 connection. The Hub pulls information from disparate databases and data files including the attributes of the data files (each a “Source”) through one or more software routines within the business enterprise or outside of the business enterprise. Each Source is assigned a unique identifier within the Hub.
2. This identifier is linked to all data and information pulled into the Hub from the specified Source.
3. Data and information from selected or all of the Sources are initially duplicated on the Hub using existing data transfer programs to a holding and staging station (the “Staging”) prior to transfer into the Hub. At the Staging, each piece of information or data item can be optionally tested for suitability for publishing to the Hub (e.g., the IS determines that the Hub will only handle manufacturing parts and would not accept used office equipment), conformed to the data storage system of the Hub, and assigned a unique identifier linking it to a Warehouse, and other attributes attached to the inventory part for tracking and processing. Subsequently, the IS can update data or information from the specified Source or Sources on a scheduled or as-needed basis as determined by the IS. No data or information at the Sources is altered or changed or manipulated at the Source level.
4. The Hub maintains primary responsibility as a depositary for inventory information, and as manager of database access and database view. The Hub operates in a database format in which all data is maintained. The Hub operates as a gatekeeper to filter all data for all permitted viewers of data and regulates both what types of data a viewer can access and view (“Data View”) and the Sources from which such type of data can be viewed (“Data Scope”). As an example of a Data View (which shall not limit the scope of this patent application), data for an expense report are arranged in a column format like Excel identified by types such as date, description, location and amounts. A viewer can be limited in his Data View by being allowed to access only the “date” and the “location” but not the “description” and the “amounts.” As an example of a Data Scope, a viewer can be limited in his Data Scope by being allowed to access only the expense reports information for particular members of his group, and may be further restricted by the Manager by dates, location of trips, or other restrictions as allowed by the Hub.
5. Each user (“User”) accessing the Hub to view data stored in the Hub is assigned a unique identifier (log-in ID) and password utilized by the Hub to identify each upon their log in into the Hub. Each User is further assigned by a Manager to a Community or Subcommunity. Each User can belong to more than one Community, but upon log-in, must identify the Community through which the User wishes to access the Hub for that sesssion.
6. A User who is responsible for managing other viewers is designated by the Hub as a “Manager.” Within a Community, there is a hierarchy of Managers, such that the highest level of Manager can access the full range Data View and Data Scope of the Community. The Data View and the Data Scope of a Manager is limited by the scope of the assigned Community; however, within such limits, the Manager can set up new Subcommunities, designate subordinate Managers and Users, limits the Data View and Data Scope of the Sub-Managers and Users in his direct line of control, remove subordinate Managers and Users in his direct line of control, and change the Data View and Data Scope of the Sub-Managers and Users.
7. Because each User and each Manager is uniquely identified, the Hub is able to present a unique log-in page (View page) to each User and each Manager upon each log-in of the User or Manager. Similarly, the Hub is able to limit each Manager and User to approved Data Views, Data Scopes, and approved activities (Approved Activities) based on predetermined criteria. Representative examples of Data Views, Data Scopes, and Approved Activities for a specified User may include the following scenario:
   A Manager associated with the Product X Group is in charge of sourcing inventory for the Product X. After approval from the Hub, designation as a Manager and assignment to a Group (Product X Inventory Sourcing Group) and a Community (Product X Community), this Manager is allowed to do the following activities: (i) view all data within the Data View and Data Scope within the Community if he has no superior Manager within the Community, or, if he has a superior Manager, as approved for his level of access by his superior Manager; (ii) designate new subordinate Managers and Users, (iii) remove subordinate Managers and Users; (iv) change the Data View and Data Scope of his subordinate Managers and Users; and (v) design, run and receive reports regarding the activities of his subordinate Managers and Users with respect to the data residing in the Hub. A Manager is allowed to set his log-in View page to include any or all or a combination of his Approved Activities. A Manager can also do all of the activities that his subordinate Managers and Users can do.
   All activities of the Users are recorded and sent back to the Hub. If a User is authorized to act on the information received through his Data View and Data Scope, for example, place sales or buy orders, all actions are then transferred from the Hub to the underlying database for further actions, such that the User does not have direct access to the underlying databases.
   All action items and transactions of the Users and Managers are recorded at the Hub and instantly updated and populated throughout the IVMDS such that the IVMDS is a dynamic and iterative system.

Approved Activities described herein are intended to be within the scope of the invention and optionally described in more details in further applications in compliance with patent laws and regulations.
8. Referring now to FIG. 3, an example workflow which could be implemented in the IVDMS shown in FIG. 2 is shown for the operational activities of a Manager using the software routines supported by the IVDMS shown in FIG. 2 to manage the Communities, the Users and the data within the IVDMS. Upon Manager log-in 301, the Hub validates the Manager's name, password and administration privileges 302, and retrieves the unique log-in page for the Manager, including a list of Community(ies) to which the Manager is assigned 303. The Manager must select one Community (if he is assigned to more than one Community) for each log-in session 304. Upon the Manager's selection of a Community, the Hub then retrieve all accessible locations for the selected Community for the specified Manager, all accessible data views and data scopes for the specified Manager, and all executable internal and external functions for the specified Manager 305. The Manager can then select from among the locations, data views, data scopes and executable internal and external functions available to him 306 through specified administrative software routines 307 through 309. The Manager can proceed to log-out at any time during the sequence 310.
9. Referring now to FIG. 4 a flowchart and a software screenshot are shown of a representative software routine for a Manager of a Community to register a new Subcommunity. After the Manager has logged in as shown in FIG. 3 and made his selection to register a new Subcommunity, the Hub retrieves and display all Attributes of the Community (for example, locations, views, processes, dashboards, Data Sources, Data Scopes) 401. The Manager then selects all or a selection of the Attributes he wishes to assign to the new Subcommunity 402. The Manager then must assign a new name for the Subcommunity 403 and enters the name into the Hub 404, whereupon a new Subcommunity if created by the Hub.
10. Referring now to FIG. 5 a flowchart is shown of a representative software routine for a Manager of a Community to register a new User or Manager. FIG. 5a and FIG. 5b are representative software screenshots of the software routine. After the Manager has logged in as shown in FIG. 3 and made his selection to register a new User or Manager, the Hub provides a screenshot functionally as set forth in FIG. 5a. The Manager then enters a new User or Manager name and password 501, and assigns the User or Manager to a Community 502. Upon the Manager's selection of a Community, the Hub retrieves and display all Attributes of the Community (for example, locations, views, processes, dashboards, Data Sources, Data Scopes) 503. The Manager then must specify whether the new user is a User (restricted access to Attributes of the Community) or Manager (unrestricted access to all Attributes of the Community) 504. If the new user is a Manager, the software routine then prompts the Manager to save the new Manager as an authorized Manager 505 and the new Manager will have all management privileges of this Community; if a new user, then the Manager must select all or a selection of the Attributes including Data Views and Data Scopes he wishes to permit the new User to access and view 507. The Manager then enters the name into the Hub 508, whereupon a new User or Manager is recorded into the Hub, and will have all privileges in the Community, except as restricted for such User by the Manager. FIG. 5b is an example screen shot showing the Manager the restrictions of data views and data scopes placed on the users within his Community, and the Manager will have the further option of deleting, changing, adding restrictions using software routines accessible as represented in this screen shot.
11. Referring now to FIG. 6 a flowchart is shown of a representative software routine for a Manager of a Community to register a new Attribute. FIG. 6a is a representative software screen shot of the software routine described in FIG. 6. After the Manager has logged in as shown in FIG. 3 and made his selection to register a new Attribute, the Hub provides a screenshot functionally as set forth in FIG. 6. The Manager then select a new Attribute type, e.g, location, new views, new data source, new process or new data set 602, registers the new Attribute 603 then assigns the new Attribute to a Community 604. The Manager then enters the Attribute into the Hub 604, whereupon the new Attribute is recorded into the Hub.

The foregoing description of the IVDMS and the exemplary embodiment of the invention have been presented for the purposes of illustration and description. It is not intended to be exhaustive or to limit the invention to the precise form disclosed. Many modifications and variations are possible in light of the above teaching. It is intended that the scope of the invention be limited not with this detailed description, but rather by the claims appended hereto. It will be appreciated by one skilled in the art that this system can be configured utilizing modem application server, XML or .NET technology provided by software vendors like IBM, Microsoft, Oracle etc. without departing from the scope and spirit of the present invention.

What is claimed is:

1. A computer-implemented method for establishing, deleting, managing virtual communities and subcommunities for the purpose of dynamically and iteratively controlling user access to viewing, managing, searching, delivering, tracking, and updating users, data, attributes and views consisting the steps of:
specifying a data hub consisting of an information management system and storage means;
specifying a plurality of sources containing data;
specifying at least one Community comprising of the universe of data, users, managers and views;
specifying a plurality of users of data for access to the system;
specifying a plurality of attributes to be viewed, accessed and activated by the users;
specifying at least one manager for management of communities, adding, deleting and placing new restrictions on users, data, views and software routines;
constructing a plurality of software routines with coupling means to the sources, the communities, the users, the managers and the attributes and containing at least one software routine to set up, register and manage communities and subcommunities nested within the higher level community (i.e., any change to the user base, attributes, data, actionable software routines affecting a higher level community cascades down to all subcommunities, managers and users within the higher level community, but not vice versa), one software routine to set up, register and manage users, managers and Sources, one software routine to do data transfer, filtering and validation, one software routine to define and assign attributes, one software routine to extract, transfer and load data, one software routine to search and match data based on user-specified criteria, one software routine for search result presentation and data presentation and display, one software routine for transaction execution and tracking, one software routine for updating change to the data hub, and one software routine for administrative functions;
with respect to administrative means within the execution of the computer implemented method, permitting the manager of a community to
register and assign each user with unique identifier to a community or subcommunity and set limits of data views and data scopes for such users,
register and assign attributes to a community or subcommunity,
register new subcommunities and managers and set limits of data views and data scopes for such communities,
open and close subcommunities, where an opened subcommunities deliver access to all users within the subcommunities, and a closed subcommunities will deprive access to all users within the subcommunities;
collect and generate reports for a specified user, manager, community, or attribute such reports to cover the scope of all allowable data views, data scopes as determined by the manager profile;
with respect to administrative means within the execution of the computer implemented method, permitting a user assigned to a community to
set limits of data views and data scopes for such users within the maximum data view and data scope available to such user,
collect and generate reports for a specified user, manager, community, or attribute such reports to cover the scope of all allowable data views, data scopes as determined by the user profile;
complete actionable items and software routines allowable to such users as determined by the user profile;
with respect to data views and data scopes requests from users, loading of data and data sources based to said data hub, searching and matching data to be presented to users based on specified limits of data views and data scopes, presenting search results, executing and tracking, actionable transactions and routines to the limits specified by the manager of the community for such users,
executing and tracking changes to users and managers, attributes, communities and data, and updating changes to said data hub and transmitting changes to initial data sources automatically and iteratively by software without human intervention;

2. The computer implemented method of claim 1, where the software routine to present views to users and managers include at least on routine to retrieve and display new inputs and data dynamically and iteratively without further human intervention on a schedule or optionally as triggered by user-defined criteria;

3. The computer implemented method of claim 1, where the software routine to search and display communications include at least one routine to allow users and administrators to define their own search and display criteria;
